(19) United States
(12) Patent Application Publication
(10) Pub. No.: US 2007/0217939 A1
(43) Pub. Date: Sep. 20, 2007

(54) GAS-COMPRESSION MODULE FOR A FUEL CELL

(76) Inventors: Kazuho SATO, Kariya-shi (JP); Kotaro IKEDA, Susono-shi (JP)

Correspondence Address: KNOBLE YOSHIDA & DUNLEAVY LLC;Eight Penn Center, Suite 1350, 1628 John F. Kennedy Blvd., Philadelphia, PA, 19103, US

(21) Appl. No.: 11/687,399

(22) Filed: Mar. 16, 2007

(30) Foreign Application Priority Data
Mar. 20, 2006 (JP) P2006-076160

(51) Int. Cl. F01C 21/06; F03C 2/00

(52) U.S. Cl. 418/206.1; 418/83

(57) ABSTRACT

A gas-compression module for use in a fuel cell system includes an air compressor, a motor and an intercooler. The air compressor has a pump chamber for compressing gas. The motor has a drive shaft for driving the air compressor. The intercooler cools the compressed gas exhausted from the air compressor. The air compressor includes a first rotor and a main rotary shaft connected to the drive shaft of the motor for driving the first rotor. The air compressor also includes a second rotor and a driven rotary shaft driven by power transmitted from the main rotary shaft for driving the second rotor. The motor and the intercooler exist in an imaginary plane passing through an axis of the main rotary shaft and an axis of the driven rotary shaft. The center of gravity of the intercooler is located closer to the driven rotary shaft than that of the motor.

### BACKGROUND OF THE INVENTION

The present invention relates to a gas-compression module for supplying compressed air to a fuel cell stack.

In a fuel cell system, it is desired to effectively supply oxidative gas (air) to the fuel cell stack together with fuel gas (hydrogen). Japanese Patent Application Publications Nos. 2004-360652, 2005-180421 and 2005-155554 disclose gas-compression modules which use roots type air compressors for supplying large amount of compressed air to the fuel cell stack.

Although a roots type air compressor has high efficiency of electric power, by combining the air compressor with a motor that serves as a drive unit, the motor is located on one side of the air compressor to unbalance the center of gravity of the air compressor with the motor, which makes it easy to generate vibration in operation of the air compressor. Since such vibration makes the gas-compression module unstable, it is not favorable to the fuel cell system. It is actual condition that the prior art gas-compression modules have not sufficiently solved the above problem.

The present invention is directed to a gas-compression module for use in a fuel cell system, the center of gravity of the gas-compression module being stabilized.

### SUMMARY OF THE INVENTION

In accordance with a first aspect of the present invention, a gas-compression module for use in a fuel cell system includes an air compressor, a motor and an intercooler. The air compressor has a pump chamber for compressing gas. The motor has a drive shaft for driving the air compressor. The intercooler cools the compressed gas exhausted from the air compressor. The air compressor includes a first rotor accommodated in the pump chamber and a main rotary shaft connected to the drive shaft of the motor for driving the first rotor. The air compressor also includes a second rotor accommodated in the pump chamber and a driven rotary shaft driven by power transmitted from the main rotary shaft for driving the second rotor. The motor and the intercooler exist in an imaginary plane passing through an axis of the main rotary shaft and an axis of the driven rotary shaft. The center of gravity of the intercooler is located closer to the driven rotary shaft than that of the motor.

In accordance with a second aspect of the present invention, a gas-compression module for use in a fuel cell system includes an air compressor, a motor and an intercooler. The air compressor has a pump chamber for compressing gas. The motor has a drive shaft for driving the air compressor. The intercooler cools the compressed gas exhausted from the air compressor. The air compressor includes a first rotor accommodated in the pump chamber and a main rotary shaft connected to the drive shaft of the motor for driving the first rotor. The air compressor also includes a second rotor accommodated in the pump chamber and a driven rotary shaft driven by power transmitted from the main rotary shaft for driving the second rotor. The intercooler is located radially outward of the pump chamber. The intercooler is located on the opposite side to the driven rotary shaft relative to the main rotary shaft.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a schematic view showing the entire structure of a fuel cell system;

FIG. 2 is a sectional view showing a gas-compression module according to a first embodiment of the present invention;

FIG. 3 is a sectional view showing a pump chamber of the gas-compression module;

FIG. 4 is a front view showing the gas-compression module according to the first embodiment of the present invention;

FIG. 5 is a sectional view showing a gas-compression module according to a second embodiment of the present invention;

FIG. 6 is a front view showing the gas-compression module according to the second embodiment of the present invention;

FIG. 7 is a sectional view showing a gas-compression module according to a third embodiment of the present invention; and

FIG. 8 is a front view showing the gas-compression module according to the third embodiment of the present invention

### DETAILED DESCRIPTION OF THE PREFERRED EMBODIMENTS

The following will describe embodiments of a gas-compression module for use in a fuel cell system of the present invention.

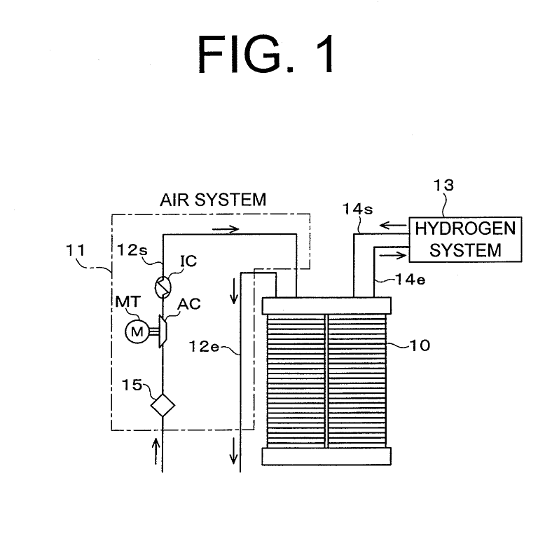

FIG. 1 is a schematic view showing the entire structure of the fuel cell system as embodied in the first embodiment of the present invention. The fuel cell system includes a fuel cell stack 10, an air system 11 and a hydrogen system 13.

The fuel cell stack 10 is a solid polymer type fuel cell having a stack structure where a plurality of single cells each generating electricity are laminated. Each of the single cells has a pair of metallic plates (each plate being referred to as a separator) and a membrane electrode assembly (MEA) interposed between the separators. The MEA has a pair of electrode catalyst layers and an electrolytic membrane made of solid polymer material interposed between the electrode catalyst layers. Each of the single cells is a generating module. The MEA generates electricity by supplying the fuel gas (hydrogen) and oxidative gas (air) to the two electrode catalyst layers.

One of the paired separators has a groove for forming a hydrogen passage through which hydrogen is supplied to the corresponding electrode catalyst layer of the MEA and the hydrogen which is not used for generating chemical reaction is exhausted. The other separator has a groove for forming an air passage through which air is supplied to the corresponding electrode catalyst layer of the MEA and the air which is not used for generating chemical reaction is exhausted. In addition, each separator has a groove for forming a passage through which cooling water passes to cool the MEA. Furthermore, the separator made of metallic plate also serves to collect power.

The air system 11 takes supply and exhaust of air for the fuel cell stack 10. The air system 11 includes an air supply pipe 12s for supplying air to the fuel cell stack 10 and an air exhaust pipe 12e for exhausting air exhausted from the fuel cell stack 10 to the outside thereof. The air supply pipe 12s is provided with an air cleaner 15, an air compressor AC downstream of the air cleaner 15 and an intercooler IC downstream of the air compressor AC. The air compressor AC is connected to a motor MT that serves as a drive unit.

The air system 11 may be provided with humidification module for humidifying the air supplied to the fuel cell stack 10. Pressure or flow rate of air may also be adjusted by providing an air flow meter or a pressure control valve in the air system 11. A cooling system of the intercooler IC includes an air-cooled system, a water-cooled system and other systems.

The hydrogen system 13 takes supply and exhaust of hydrogen for the fuel cell stack 10. The hydrogen system 13 includes a hydrogen supply pipe 14s for supplying hydrogen to the fuel cell stack 10 and a hydrogen exhaust pipe 14e for exhausting hydrogen exhausted from the fuel cell stack 10 to the outside thereof. Although not shown in the drawing, a hydrogen tank, a valve and so forth are provided in the hydrogen system 13. The hydrogen tank stores high-pressure hydrogen gas. The valve adjusts flow rate or pressure of hydrogen. It is noted that hydrogen gas may be produced or supplied using a reformer which improves properties of methane gas, methanol and so forth instead of hydrogen supply from the hydrogen tank.

The fuel cell system includes a cooling system (not shown) for supplying and circulating cooling water into the fuel cell stack 10 to cool the fuel cell stack 10 and an output portion (not shown) for outputting electricity generated by the fuel cell stack 10 to the outside thereof besides the above-mentioned systems.

Flow of air in the air system 11 will now be described. The air passing through the air supply pipe 12s is cleaned by the air cleaner 15, and then compressed by the air compressor AC. The compressed air has extremely high temperature (in the order of 160 degrees Celsius), which is higher than operating temperature (in the order of 120 degrees Celsius) of the fuel cell stack 10. Therefore, the compressed air is cooled by the intercooler IC and then supplied to the fuel cell stack 10.

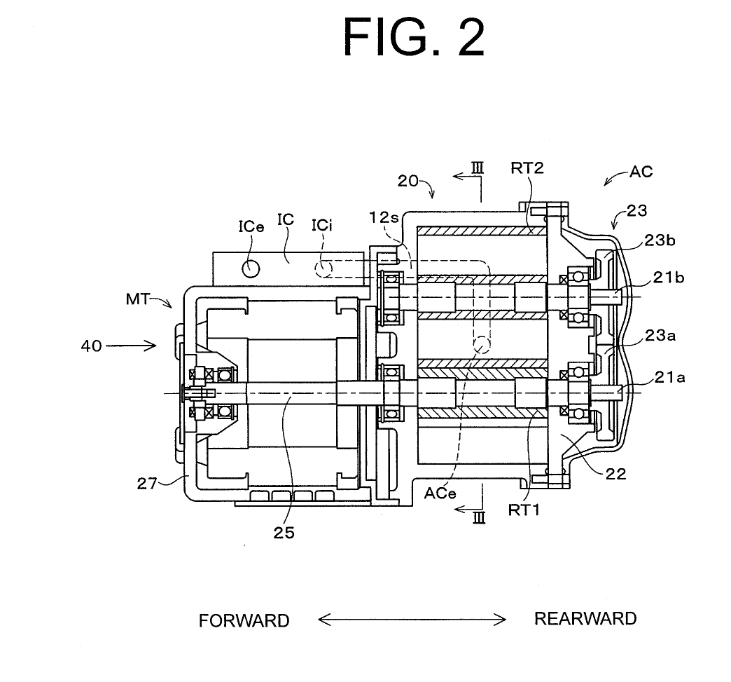

FIG. 2 is a sectional view showing a gas-compression module of the first embodiment for use in the above-mentioned fuel cell system. In FIG. 2, the left side of the gas-compression module and the opposite right side thereof correspond to the front side and the rear side of the gas-compression module, respectively. The gas-compression module is formed by combining the air compressor AC, the motor MT and the intercooler IC together, which forms a part of the air system 11 of the above-mentioned fuel cell system.

The air compressor AC is preferably of a two-shaft type having two rotors, and in the present embodiment a roots type air compressor whose power efficiency is particularly high in the two-shaft type air compressor is employed. The air compressor AC includes a pump chamber 20 and a gear chamber 23 divided by a partition 22. The air compressor AC also includes a main rotary shaft 21a and a driven rotary shaft 21b which extend through the pump chamber 20. The main rotary shaft 21a is connected to a first rotor RT1 in the pump chamber 20, and the driven rotary shaft 21b is connected to a second rotor RT2 in the pump chamber 20.

One end of the main rotary shaft 21a which extends from the partition 22 into the gear chamber 23 is connected to a first gear 23a which is accommodated in the gear chamber 23. The first gear 23a is engaged with a second gear 23b which is also accommodated in the gear chamber 23, and the second gear 23b is connected to the driven rotary shaft 21b. Such a structure enables rotary driving force of the motor MT to be transmitted from the main rotary shaft 21a to the driven rotary shaft 21b through the gears 23a, 23b thereby to drive the rotors RT1, RT2.

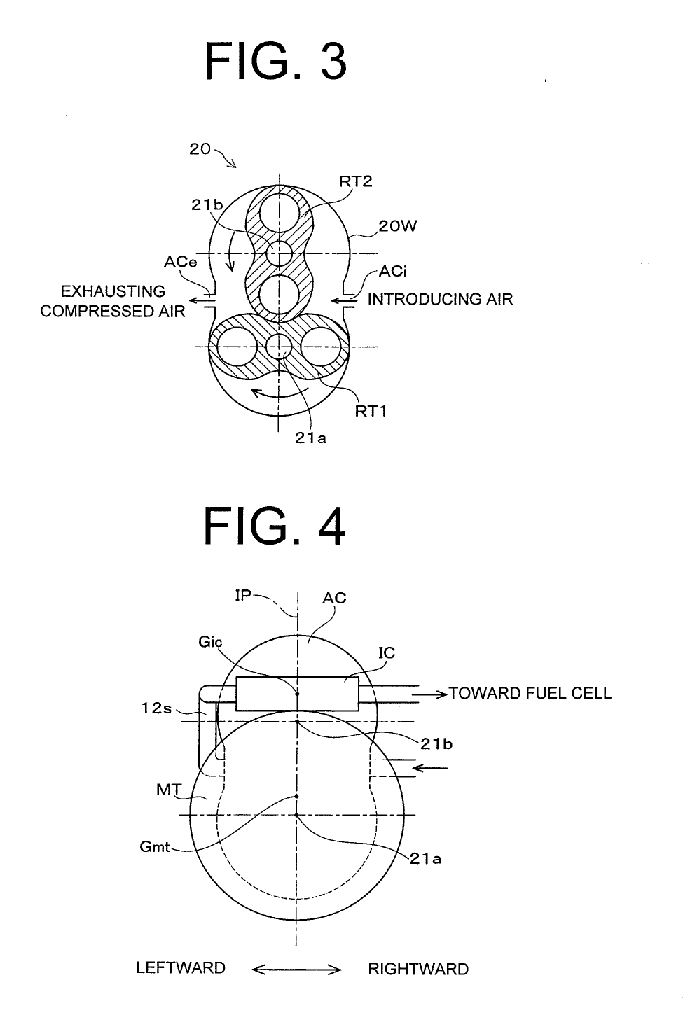

Operation of the air compressor AC will now be described. FIG. 3 is a sectional view showing the interior of the pump chamber 20 of the air compressor AC as seen from the line III-III of FIG. 2. As shown in FIG. 3, each of the rotors RT1, RT2 is of a roughly figure “8” shape with symmetric shape, and the rotors R1, R2 are arranged in engaging relation. The rotors RT1, RT2 are rotated on the rotary shafts 21a, 21b in the directions indicated by arrows, respectively, at the same rotational speed. This structure enables the air compressor AC to change volume of space formed between an inner wall 20W of the air compressor AC and the rotors RT1, RT2, whereby air is introduced from an intake port ACi, compressed in the pump chamber 20 and then the compressed air is exhausted from the exhaust port ACe.

Referring back to FIG. 2, the gas-compression module will be described. A drive shaft 25 of the motor MT is connected to the main rotary shaft 21a of the air compressor AC. While the air compressor AC has two rotary shafts 21a, 21b, the motor MT has a single drive shaft 25. Assuming that the intercooler IC is removed from the gas-compression module of FIG. 2, although there exists the motor MT on the front side of the main rotary shaft 21a of the pump chamber 20, there exists no component on the front side of the driven rotary shaft 21b thereof whereby the air compressor AC and the motor MT have a stepped shape therebetween. Such a combination of only the air compressor AC and the motor MT is unstable as shape. In addition, since there is a weight difference between the air compressor AC and the motor MT, as a whole the center of gravity is also unbalanced. To reduce the above problem, the gas-compression module of the present embodiment is so formed that the intercooler IC located downstream of the air compressor AC is combined with the air compressor AC.

An intake port ICi of the intercooler IC is connected to the exhaust port ACe of the air compressor AC. An exhaust port ICe of the intercooler IC is connected to the fuel cell stack 10. The intercooler IC is fixed so as to have contact with a casing 27 of the motor MT. The center of gravity of the intercooler IC is located closer to the driven rotary shaft 21b of the air compressor AC than that of the motor MT.

FIG. 4 is a front view showing the gas-compression module as seen in the direction of arrow 40 of FIG. 2. It is preferable that the intercooler IC is arranged so as to maintain the balance in the rightward and leftward directions of FIG. 4. Namely, it is preferable that the center of gravity Gic of the intercooler IC and the center of gravity Gmt of the motor MT exist in an imaginary plane IP passing through an axis of the main rotary shaft 21a and an axis of the driven rotary shaft 21b. In such a structure, unbalance of the center of gravity in the direction perpendicular to the imaginary plane IP is reduced. It is noted that the center of gravity Gic of the intercooler IC and the center of gravity Gmt of the motor MT may be positioned so as to deviate from the imaginary plane IP to a certain extent.

As described above, the unbalance of the center of gravity of the gas-compression module is reduced by the weight of the intercooler IC thereby to enable the stable operation of the gas-compression module. In addition, it is possible to effectively utilize the space (dead space) formed on the front side of the driven rotary shaft 21b of the air compressor AC, which makes the gas-compression module compact. Therefore, the gas-compression module is effective in introducing the fuel cell system into a limited narrow space such as a vehicle. Furthermore, since the intercooler IC is arranged closer to the air compressor AC, a path of the pipe through which compression air with high temperature and high pressure passes is shortened. Therefore, pressure loss of the entire path of pipes after the air compressor AC is reduced.

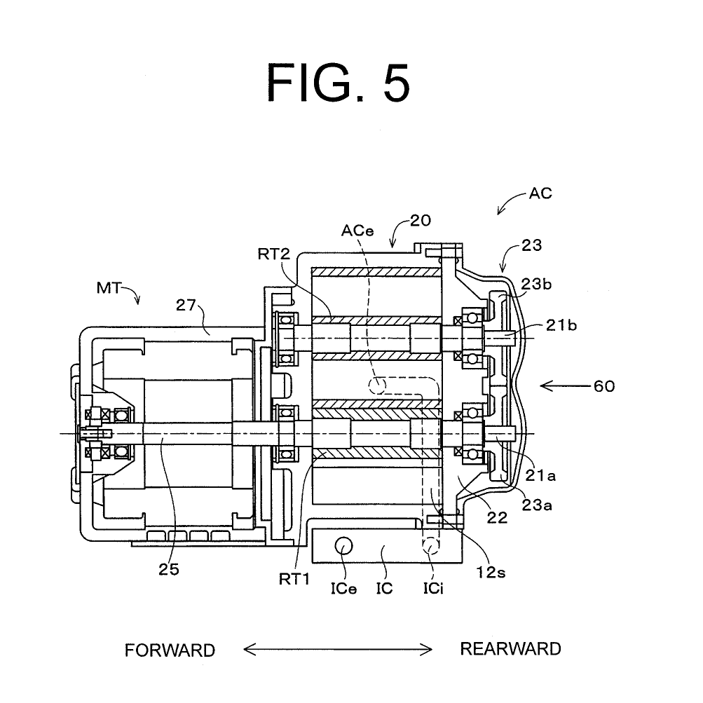

FIG. 5 is a sectional view showing a gas-compression module of the second embodiment. In FIG. 5, the left side of the gas-compression module and the opposite right side thereof correspond to the front side and the rear side of the gas-compression module, respectively. FIG. 5 is substantially the same as FIG. 2 except for the position of the intercooler IC. The intercooler IC is fixed on the side opposite to the driven rotary shaft 21b relative to the main rotary shaft 21a of the air compressor AC. The intercooler IC and the air compressor AC may be arranged so that their outer walls do not have contact with each other. Alternatively, the outer walls may have contact with each other.

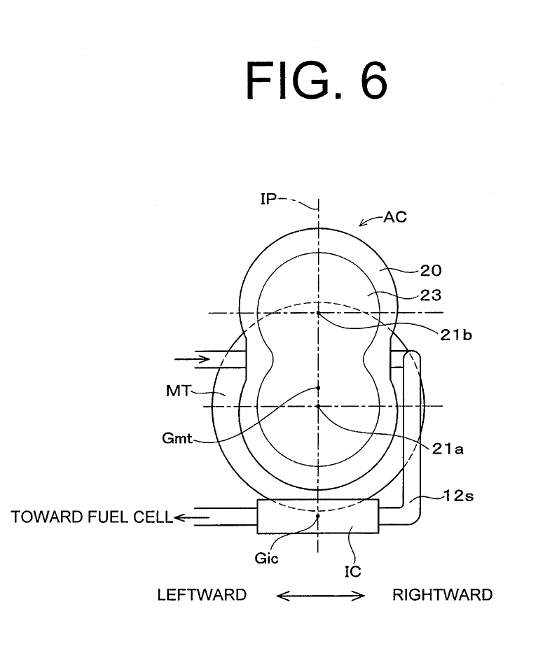

FIG. 6 is a front view showing the gas-compression module of the second embodiment as seen in the direction of arrow 60 of FIG. 5. It is preferable that the intercooler IC is arranged so as to maintain the balance in the rightward and leftward directions of FIG. 6. Namely, it is preferable that the center of gravity Gic of the intercooler IC and the center of gravity Gmt of the motor MT exist in the imaginary plane IP passing through the axis of the main rotary shaft 21a and the axis of the driven rotary shaft 21b. In such a structure, unbalance of the center of gravity in the direction perpendicular to the imaginary plane IP is reduced. It is noted that the center of gravity Gic of the intercooler IC and the center of gravity Gmt of the motor MT may be positioned so as to deviate from the imaginary plane IP to a certain extent.

According to the second embodiment, when the weight of the motor MT is larger than that of the air compressor AC (for example, the weight of the air compressor AC is 10 kg, the weight of the motor MT is 13 kg), the gross weight of the intercooler IC and the air compressor AC is brought close to the weight of the motor MT Consequently, the center of gravity of the gas-compression module is brought close to the center of the gas-compression module.

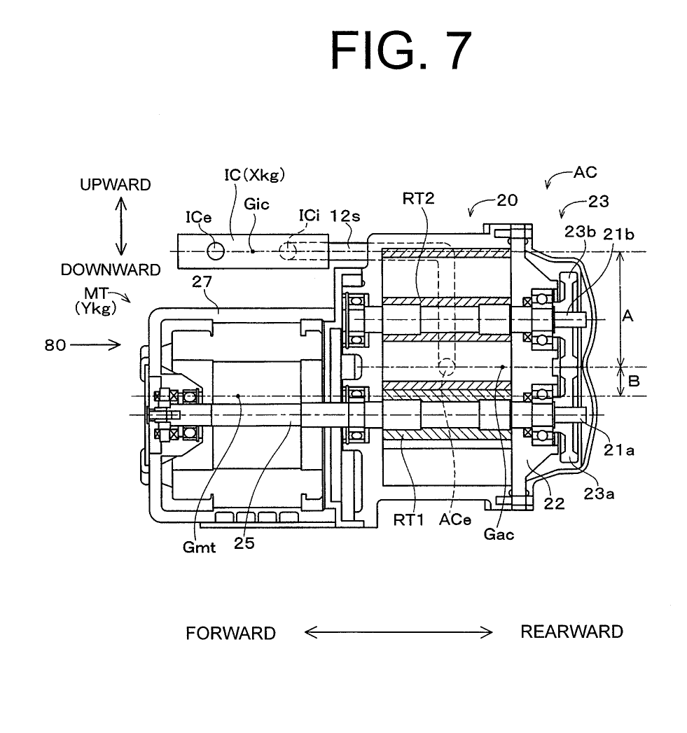

FIG. 7 is a sectional view showing a gas-compression module of the third embodiment. In FIG. 7, the left side of the gas-compression module and the opposite right side thereof correspond to the front side and the rear side of the gas-compression module, respectively. FIG. 7 is substantially the same as FIG. 2 except for the position of the intercooler IC.

Although the intercooler IC of the first embodiment is fixed so as to have contact with the casing 27 of the motor MT, the intercooler IC of the third embodiment is fixed in a position spaced away from the casing 27 in the upward direction of FIG. 7. In FIG. 7, the distance in the vertical direction between the center of gravity Gac of the air compressor AC and the center of gravity Gic of the intercooler IC is designated as a reference sign A and the distance in the vertical direction between the center of gravity Gac of the air compressor AC and the center of gravity Gmt of the motor MT is designated as a reference sign B. If the weight of the intercooler IC is X kg (for example, 1 kg) and the weight of the motor MT is Y kg (for example, 13 kg), it is preferable that the distances A, B meet the relation X:Y=B:A approximately. More specifically, it is preferable that when the value of B/A is 100%, the value of X/Y ranges in 100±10%.

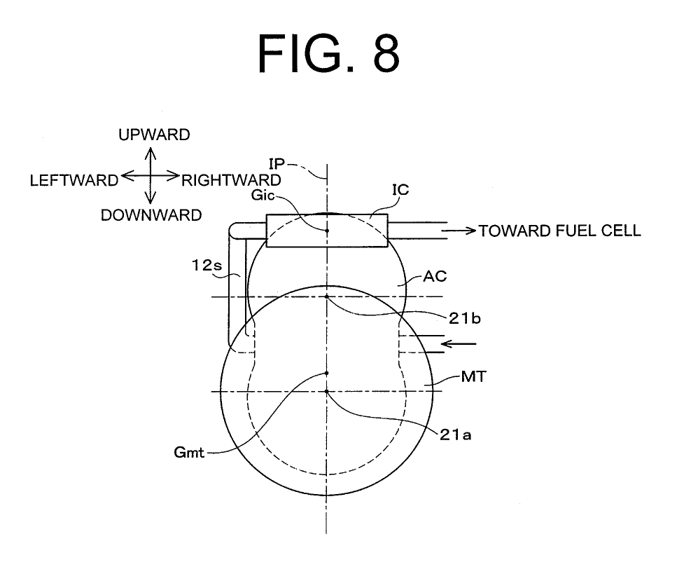

FIG. 8 is a front view showing the gas-compression module of the third embodiment as seen in the direction of arrow 80 of FIG. 7. It is preferable that the intercooler IC is arranged so as to maintain the balance in the rightward and leftward directions of FIG. 8. Namely, it is preferable that the center of gravity Gic of the intercooler IC and the center of gravity Gmt of the motor MT exist in the imaginary plane IP passing through the axis of the main rotary shaft 21a and the axis of the driven rotary shaft 21b. In such a structure, unbalance of the center of gravity in the direction perpendicular to the imaginary plane IP is reduced. It is noted that the center of gravity Gic of the intercooler IC and the center of gravity Gmt of the motor MT may be positioned so as to deviate from the imaginary plane IP to a certain extent.

By forming so, the unbalance of the center of gravity of the gas-compression module in the upward and downward directions of FIGS. 7 and 8 is reduced thereby to stabilize the gas-compression module.

The present invention is not limited to the above-mentioned embodiments, but may be variously modified within departing from the scope of the invention. For example, the following modifications of the embodiments are practicable.

Although in the above embodiments the intercooler IC also serves as a weight for maintaining a balance, the position of the center of gravity may be further adjusted by actually adding a weight to the intercooler IC. In this case, “the center of gravity of the intercooler IC” means the center of gravity of the weighted intercooler IC.

Therefore, the present examples and embodiments are to be considered as illustrative and not restrictive, and the invention is not to be limited to the details given herein but may be modified within the scope of the appended claims.

What is claimed is:

1. A gas-compression module for use in a fuel cell system comprising:
an air compressor having a pump chamber for compressing gas;
a motor having a drive shaft for driving the air compressor;
an intercooler for cooling the compressed gas exhausted from the air compressor;
wherein the air compressor includes a first rotor accommodated in the pump chamber and a main rotary shaft connected to the drive shaft of the motor for driving the first rotor, the air compressor also including a second rotor accommodated in the pump chamber and a driven rotary shaft driven by power transmitted from the main rotary shaft for driving the second rotor, and
wherein the motor and the intercooler exist in an imaginary plane passing through an axis of the main rotary shaft and an axis of the driven rotary shaft, the center of gravity of the intercooler being located closer to the driven rotary shaft than that of the motor.

2. The gas-compression module according to claim 1, wherein the center of gravity of the intercooler and the center of gravity of the motor substantially exist in the imaginary plane.

3. The gas-compression module according to claim 1, wherein the intercooler is located on a casing of the motor.

4. The gas-compression module according to claim 1, wherein the intercooler is spaced away from a casing of the motor.

5. The gas-compression module according to claim 1, wherein the intercooler is located so that value of X/Y ranges in 100±10% of that of B/A where distance between the center of gravity of the air compressor and the center of gravity of the intercooler is A, distance between the center of gravity of the air compressor and the center of gravity of the motor is B, weight of the intercooler is X, and weight of the motor is Y.

6. The gas-compression module according to claim 1, wherein the air compressor is of a roots type.

7. A gas-compression module for use in a fuel cell system comprising:
an air compressor having a pump chamber for compressing gas;
a motor having a drive shaft for driving the air compressor;
an intercooler for cooling the compressed gas exhausted from the air compressor;
wherein the air compressor includes a first rotor accommodated in the pump chamber and a main rotary shaft connected to the drive shaft of the motor for driving the first rotor, the air compressor also including a second rotor accommodated in the pump chamber and a driven rotary shaft driven by power transmitted from the main rotary shaft for driving the second rotor, and
wherein the intercooler is located radially outward of the pump chamber, the intercooler being located on the opposite side to the driven rotary shaft relative to the main rotary shaft.

8. The gas-compression module according to claim 7, wherein the air compressor is of a roots type.
